(19) United States
(12) Patent Application Publication
(10) Pub. No.: US 2007/0217579 A1
(43) Pub. Date: Sep. 20, 2007

(54) SYSTEM AND METHOD FOR ENHANCED VOICE MAIL

(76) Inventors: Arun SOBTI, Milpitas, CA (US); Piyush C. Modi, Milpitas, CA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/688,755

(22) Filed: Mar. 20, 2007

Related U.S. Application Data
(60) Provisional application No. 60/783,408, filed on Mar. 20, 2006.

(51) Int. Cl. H04M 1/64

(52) U.S. Cl. 379/67.1

(57) ABSTRACT

The present invention is directed to methods, systems and apparatuses for an enhanced voice mail system. The enhanced voice mail system provides integrated access to media rich content such as e-mail, voice mail, fax, video clips, or digital still images accessed from a variety of Internet communities. The enhanced voice mail system provides the ability for a subscriber to participate in the community of activities that the Internet provides via a voice mail box while maintaining the anonymity associated with the Internet. This ability includes the retrieval of information from specific web postings and/or messages intended for the member and retrieval of responses to the web postings. In addition, the enhanced voice mail system provides the capability for developing continuation messages which mix (or superimpose) messages from a plurality of users.

### CROSS REFERENCE TO RELATED APPLICATIONS

The present application claims the benefit of U.S. Provisional Patent Application No. 60/783,408, filed on Mar. 20, 2006, which is incorporated herein by reference in its entirety.

### BACKGROUND OF THE INVENTION

1. Field of the invention

The invention relates generally to a network based solution for integrating audio and video communications over a variety of network devices, and particularly to an enhanced voice mail system and method.

2. Background Art

Conventional voice mail systems deployed on broadband, wireless and wireline media face overly long time-to-market cycles, and expensive migrations from legacy systems to newer Internet Protocol (IP) based technologies. Many times there are mismatches in integrating IP based devices, platforms and services because of the fact that different vendors follow different standards in implementing IP based services. As a result, present voice mail systems are not fully exploited in terms of their functional usage capabilities as far as accessing voice messages from a multitude of IP based devices and interfaces, providing access to media rich contents, prioritizing and filtering messages, navigating websites using voice inputs and other similar advanced operations are concerned.

What is needed is a standards based, scalable and seamlessly operable voice mail system and method that can have ubiquitous access through a variety of networked devices like cellular phones, Personal Digital Assistants (PDAs), personal computers (PCs), web based interfaces and services, and the like.

### SUMMARY OF THE INVENTION

Methods, systems and apparatuses for an enhanced voice mail system (also interchangeably referred to as voice mailbox system and/or voice mailbox) are provided. The voice mailbox can be an enhanced network based solution for depositing and receiving speech, video or text along with a variety of enhanced features like instant conferencing, organizing voice mails into folders or “bins,” addition of background tone, concatenation of messages, ability to navigate a website, and/or other enhanced features.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A illustrates an exemplary environment in which an enhanced voice mailbox system can be implemented, according to one embodiment of the present invention.

FIG. 1B illustrates the enhanced voice mailbox system in terms of exemplary constituent modules, according to an embodiment of the present invention.

FIG. 2 illustrates a message received by a user of the enhanced voice mailbox system.

FIG. 3 illustrates a user initiating a conference, according to an embodiment of the invention.

FIG. 4 illustrates one or more users connected to a conference via the enhanced voice mail box system, according to another embodiment of the invention.

FIG. 5 illustrates real time sharing of a message between various users, according to yet another embodiment of the present invention.

FIG. 6 illustrates a flowchart for connecting to a conference via the voice mailbox system.

FIG. 7 illustrates a flowchart for sharing a message between various users.

FIG. 8 shows accessibility of the voice mailbox system from a variety of electronic devices.

### DETAILED DESCRIPTION OF THE INVENTION

Introduction

Today users of IP based voice services are inundated with information. Successful voice communication requires that voice messages be easily accessed and prioritized from different locations, over different networks, using different kinds of devices. Subscribers to voice based services should be able to manage all their messages, regardless of media type (voice, fax, e-mail, etc.), from a single easy-to-access mailbox.

Enhanced Voice Mailbox

The enhanced voice mailbox according to embodiments of the invention can be a network-based solution for more than merely depositing and receiving speech, video or text, as is done with conventional voice mailbox systems. Voice mail is the most easily accessible number for all terminal devices and is rapidly becoming the most ubiquitously available. Interfacing to a voice mail system in many cases requires at a minimum, voice and a key pad. A camera and screen may be required for certain applications, such as a video application. As described herein the traditional concept of a “voice mail box” can be enhanced to provide a variety of rich media solutions. The present invention is related to an enhanced voice mailbox system with features such as easy accessibility from any remote device that can be connected to a network, ability to view the voice mail on a graphical user interface (web-based or otherwise), and ability to modify voice messages by using voice input, among other features.

Example Implementation

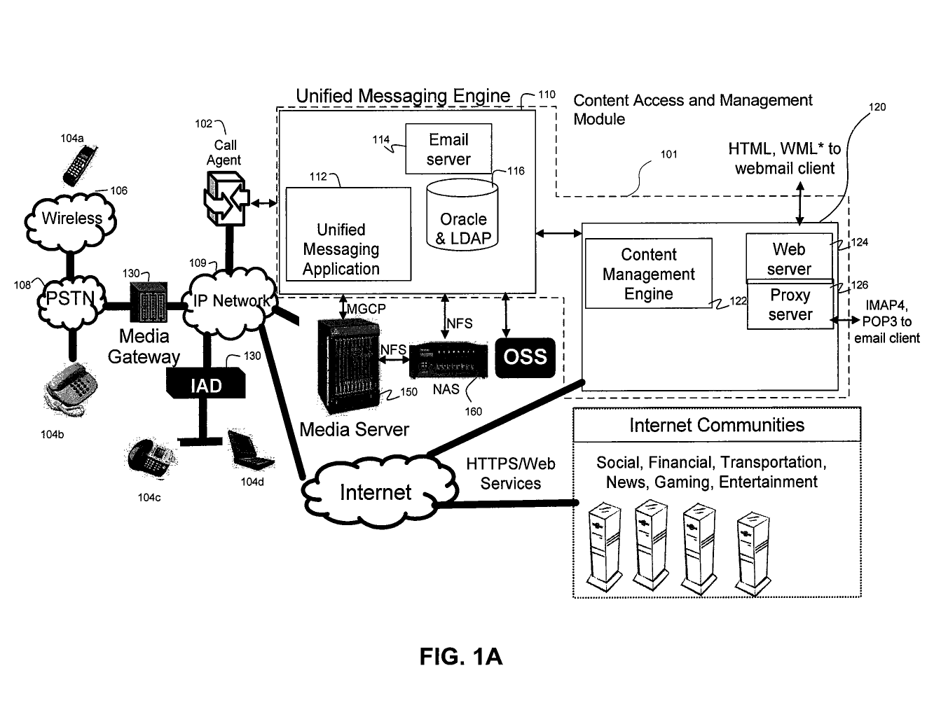

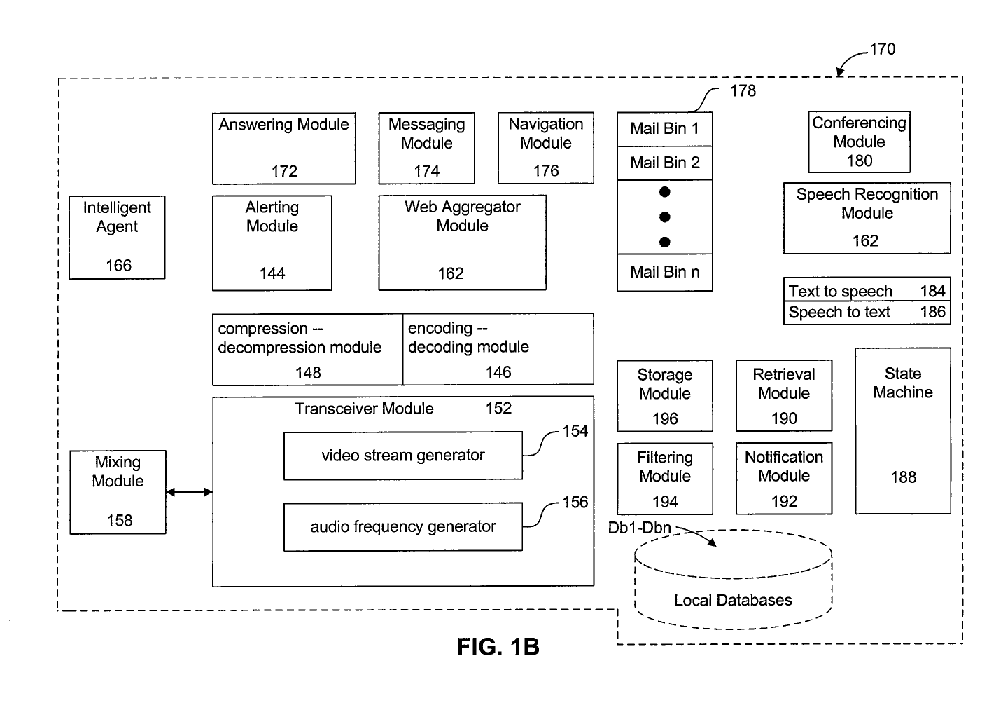

FIG. 1A provides a high level block diagram of an exemplary environment 100 in which an enhanced voice mail system 101 may be used. Enhanced voice mail system 101 includes a unified message engine 110 and content access and management module 120. Unified message engine 110 includes a unified messaging application 112, an email server 114, and a database 116. Content Access and Management module 120 includes a content management engine 122 which mines, fetches, filters, aggregates and/or deposits content, web server 124, and a web proxy 126. Enhanced voice mail system 101 may also include additional modules which will be described in more detail in FIG. 1B. Commonly known elements like speaker, microphone, antennas, connectors, amplifiers, mixer circuitry, processors, memory units, display units, and other electronic components required to implement enhanced voice mailbox system 101 have been omitted in the figures, for sake of brevity.

Enhanced voice mail system 101 of FIG. 1 integrates with switches and call agents in a communications network. For example, unified messaging engine 110 communicates with a call agent 102. In addition, unified message engine 110 communicates with end user devices 104a and 104b via a wireless network 106 and/or public switched telephone network (PSTN) 108, a media gateway 130, and an IP communications network 109. A media server 150 may be used as an intermediate device between unified messaging engine 112 and IP network 109 and may communicate with external devices using standard protocols like Media Gateway Control Protocol (MGCP). Media server 150 may further have a Network Attached Storage (NAS) 160. As is well known to one skilled in the art, NAS 150 may be substituted with a Storage Area Network (SAN) (not shown in FIG. 1A), depending on needs of specific applications. Unified message engine 110 also communicates with end user devices 104c and 104d via an internet access device (IAD 140) and IP network 109. Further, unified messaging engine 110 may be operable and/or configurable using software, for example and not by way of limitation, an Open Source Software and/or proprietary software.

Content management engine 122 retrieves and deposits messages and/or other types of information via the Internet. In addition or alternatively, content management engine 122 retrieves and deposits messages via a private communications network.

Enhanced voice mail system 101 may also include a media processing element 170, as shown in FIG. 1B, which can host speech recognition module 182, text-to-speech conversion 184 and speech-to-text conversion 186, and other features like tone recognition and generation. Media processing element 170 can mix multiple media onto a single stream with any treatment desired on each stream prior to mixing, encode/decode, compress, and decompress audio and video signals, make and receive audio and video calls to one or many parties simultaneously, generate and receive messages regarding the state of the contents of the pre-determined storage element, detect certain information patterns for state-based actions, and can decode and encode multiple schemes for audio and video information. Such functions performed by media processing element 170, as listed immediately above can be performed by its various constituent modules shown in FIG. 1B.

Various exemplary constituent modules of the media processing element 170 will now be described. It is worth mentioning that these elements of media processing element 170 are not limited by their physical location inside enhanced voice mailbox system 101. For example, elements of media processing element 170 may be shared in an appropriate manner, in part or in full, between unified messaging engine 110 and content access and management module 120. Further, elements of media processing element 170 may be programmable and can be implemented in hardware, firmware, software or any appropriate combination thereof.

Media processing element 170 includes an answering module 172 comprising hardware and/or software to manage answering to a voice message or a voice call. Answering module 172 can perform many other functions including but not limited to, recording and retrieving messages to various communities that a user of enhanced voice mailbox system 101 may have subscribed to, replying to and forwarding messages from communities, perform identity resolution across communities while preserving community specific identity and anonymity.

Media processing element 170 includes a messaging module 174 that provides for features like modifying messages per individual user's preferences. Messaging module 174 is also used for functions like single voice mail access for all media rich email, voice, fax, video clips, community specific voice, data and video greeting management and management and synchronization of subscriber identity across communities and other voice mailbox systems similar to enhanced voice mailbox system 101. Messaging module 174 can be programmed to send update messages to a user about memory quota available and/or used based on a amount of content storage in local databases Db1-Dbn. In another embodiment of the present invention, messaging module 174 can be used for billing management based on financial transactions of a user of enhanced voice mailbox system 101. Further, messaging module 174 can be used to create and manage distribution lists to various internet communities (shown in FIG. 1).

Navigation module 176 is used for assisting users to navigate websites using a voice input. For example, a user may navigate (or “surf”) the internet using a voice based interface, in addition or as an alternative to a conventional graphical user interface (GUI). Alternatively or additionally, navigation module 176 may also be used by a user of enhanced voice mail system 101 to navigate through a list of voice messages, text messages, email messages, or any combination of these.

Enhanced voice mail system 101 has the capability to organize and/or categorize various messages into mail bins 178, comprising of one or more mail bins 1-n. Mail bins 1-n may be created based on various criteria. For example, mail bins 1-n may be created based on personal, professional, or membership to various internet communities shown in FIG. 1A.

A user of enhanced voice mail system 101 may get alerts to various voice messages via alerting module 144. Such alerts could be in the form of audio signals, video signals, electromechanical vibrations, optical signal, or an appropriate combination of these. For example, such alerts could be Mobile Web Network (MWN) based alerts passing from a phone, a pager or an email and may be embedded with community specific information. Based on device capability, like devices under Mobile Web Initiative (MWI), alerting module 144 can be used to transpire community specific information. Such MWI devices can be operating under various protocols and/interfaces like Session Initiation Protocol (SIP), Simple Message Desk Interface (SMDI), MM7 protocol specified by 3^{rd} Generation Partnership Project (3GPP), or other present or futuristic protocols and/or interfaces well known to those skilled in the art that are currently in practice or will be practiced in future. By use of such interfaces and/or protocols, enhanced voice mailbox system 101 can be integrated with a variety of web-based services like internet chatting, instant messaging.

Media processing element 170 includes a web-aggregator module 162 to retrieve information from various web-postings and to note responses to the web-postings from enhanced voice mailbox 101.

A compression-decompression module 148 is used for compressing and de-compressing, respectively, various data that are transmitted from and/or received at enhanced voice mailbox system 101.

An encoding-decoding module 146 is used to perform encoding and/or decoding operations by various techniques well known to those skilled in the art, for example MPEG4 encoding and/or decoding, or other present or future encoding and/or decoding techniques.

Media processing element 170 may contain a transceiver module 152 for transmitting and/or receiving various data. As is well known to those skilled in the art, a transceiver module comprises a transmitter and a receiver. In addition, transceiver module 152 includes a video stream generator 154 and an audio frequency generator 156. Video stream generator 154 may be used for adding background video for various voice messages and/or other messages. Similarly, audio frequency generator 156 may be used for adding background audio for various voice messages and/or other messages. Both video stream generator 154 and audio frequency generator 156 may communicate with local databases Db1-Dbn (also shown in FIG. 1B), to deposit and/or retrieve audio and/or video data.

Mixing of audio and video can be performed using a mixing module 158. Mixing module 158 can mix different messages in a form recognizable by human ear. Further, mixing module 158 can be programmed to mix various messages and/or audio or video data at pre-determined times. Further still, mixing module 158 may be used to add accentuation to various voice messages by reading language data stored in local databases Db1-Dbn. Functions performed by mixing module 158 can be on a message by message basis, in a round-robin fashion or on a bulk basis, depending on specific applications.

Media processing element 170 may further include one or more intelligent agent(s) 166 that can extract pertinent information from targeted websites and deposit only information requested by a state machine 188 to a specific location for storage. Intelligent agent 166 can retrieve information from a storage location, such as local databases Db1-Dbn, and deliver it to a targeted website based upon specific instructions contained about the information.

State machine 188 may also be used to maintain various physical and functional data related to possible states of enhanced voice mailbox system 101.

A storage module 196 and a retrieval module 190 may be used for storing and retrieving, respectively, one or more audio data (interchangeably referred to as “audio frequencies”) and/or video data (interchangeably referred to as “video streams”).

Filtering module 194 enables filtering or blocking of undesirable messages and/or background noise. Filtering module 194 can be programmed by a user of enhanced voice mailbox system 101 to filter messages based upon priorities or criteria set by the user. Like other modules of media processing element 170, filtering module 194 may be operable by a user of enhanced voice mailbox system 101 remotely from any device connected to a network.

A user of enhanced voice mailbox system 101 may receive notifications about various states of his/her voice mailbox by means of a notification module 192. Such notifications may be, for example, in the form of a voice message, a video or an email. The user can set preferences to receive notifications of his or her internet based accounts or activities on internet communities. Depending upon specific applications, notification module 192 may work in conjunction with alerting module 144. Further, alerting module 144 and notification module 192 may share overlapping functionalities. Alternatively and/or additionally, alerting module 144 and notification module 192 may be independent from each other.

Media processing element 170 also includes a speech recognition module 162 (also known as a “voice recognition module”), a text-to-speech (TTS) module 184 and a speech-to-text module 186. Depending on specific applications, these modules may be in an integrated module and/or independent from each other. Speech recognition module 162 is used to train enhanced voice mailbox system 101 to learn nuances of speech or voice of one or more users of enhanced voice mailbox system 101. For example, using speech recognition module 162, a user can set identifiers for various senders of voice messages and/or perform speech-enabled community queue and message browsing in multiple languages like English, Mandarin, Spanish, Japanese, German, French, and Russian. TTS module 184 may be used to read community posted text messages over a telephone user interface.

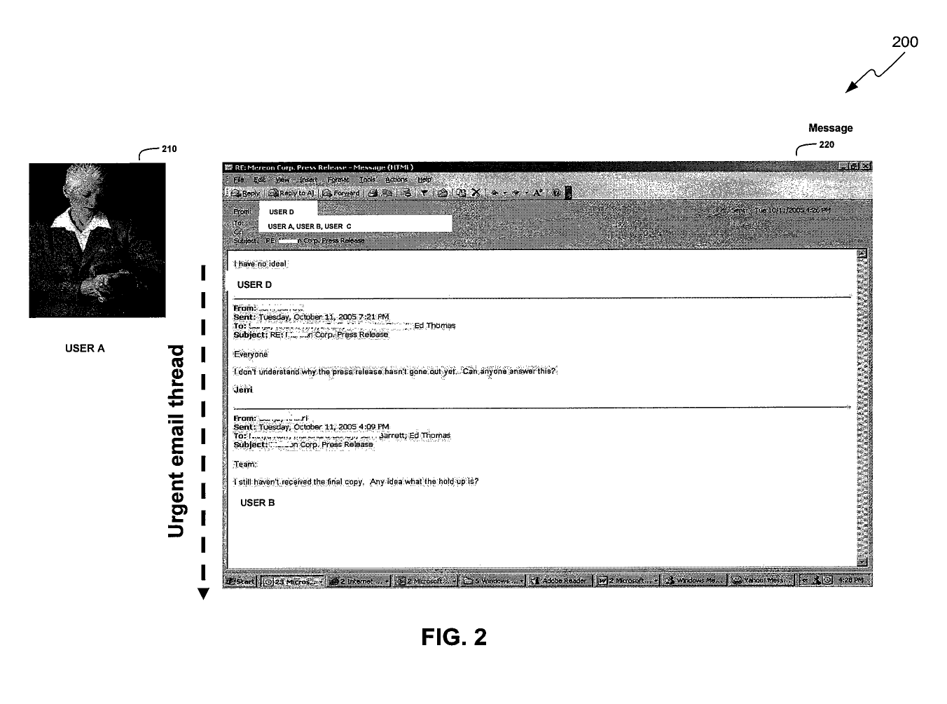

In an exemplary scenario, upon receipt of a voice message (or any other message form, like email), a user of enhanced voice mailbox system 101 may want to start a conference with one or more other users immediately. Via conferencing module 180, this can be accomplished wherein invitations for a conference can be sent out to one or more users, merely by using voice input and/or minimum hardware like a dual tone multiple frequency (DTMF) telephone keypad. More functionalities of conferencing module 180 will be apparent to those skilled in the art after reading the description of FIGS. 2-8.

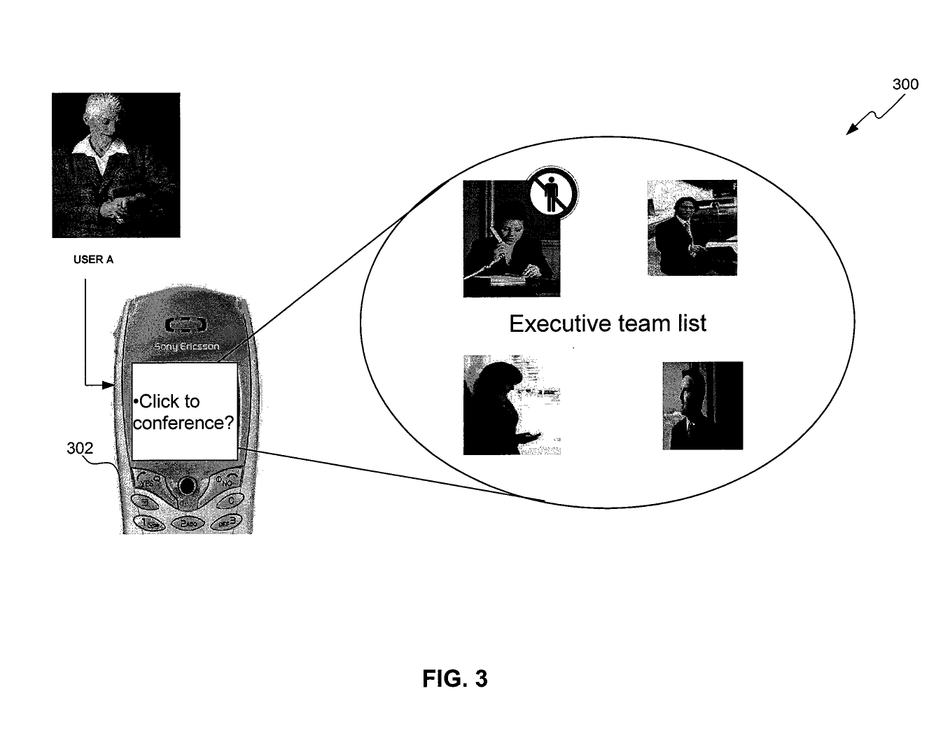

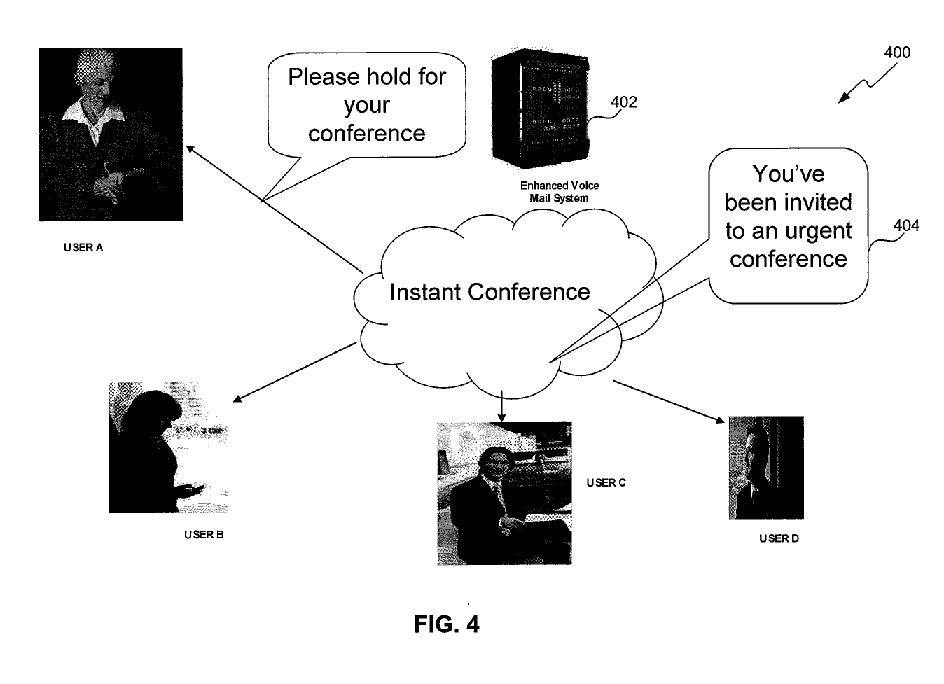

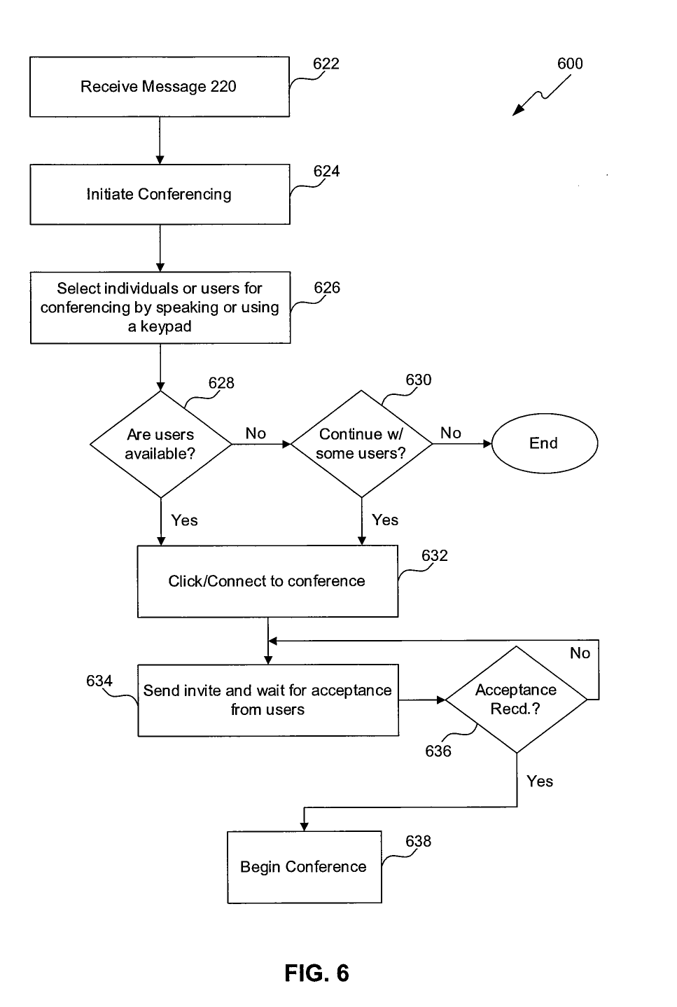

FIGS. 2-4 illustrate exemplary instant conferencing via enhanced voice mailbox system 101. As shown in FIG. 2, user A received a message in her voice mail box from user D. The message caused user A to initiate an immediate conference, via conferencing module 180 of FIG. 1B, with a set of individuals. In this example, the conference participants are the individuals listed in the “to:” and “from:” fields of the received message. As described above, user A could have selected a group of participants from her address book or by speaking their names. As shown in FIG. 3, user A's telephone provides a prompt to start the conference. Although FIG. 3 illustrates a text prompt being displayed to user A, user A may also or alternatively receive a voice prompt from enhanced voice mail system 100. As a response to the text prompt, user A initiates the conference among the four participants by sending a message 404 (shown in FIG. 4) to users B, C and D. The scenarios shown in FIGS. 2-4 will be explained in more detail by way of flowchart 600 of FIG. 6.

Enhanced voice mail system 101 also provides the ability for a user to create group greetings or messages by superimposing (as opposed to concatenating) greetings or messages. This can be accomplished by using one or more modules of media processing element 170.

It is well known that in many scenarios in the real world, one may need to send a group message from multiple users to a single recipient. For example, a single recipient may receive a single paper birthday card with messages from many senders on the same birthday card. Such a message is called a continuation message. The resulting message could be the collation of superimposed identical messages uttered by more than one person (e.g., happy birthday or congratulations) or the edited version of a message received from a third person to be passed on to the next or ultimate recipient. A similar continuation message may be created as a “voice card” by multiple users of enhanced voice mailbox system 101. Illustrative examples of continuation messages are a farewell message to a retiree, a congratulations message, or a birthday message. In these examples, instead of a traditional paper card, a voice and/or video card could be delivered. In the traditional paper card case, the card is circulated for signature. In an enhanced voice mail case, the card is a voice and/or video message that is “circulated.” For example, when an individual receives the message, the individual is prompted by the system to record the “greeting”—say “Happy Birthday.” The individual then records “Happy Birthday on cue from enhanced voice mailbox system 101. Enhanced voice mailbox system 101 then mixes the individual's greeting with greetings already provide and sends the message to the next person in queue.

In such a scenario, a subscriber is prompted by enhanced voice mail system 101 to generate a message. Using navigation module 176, the subscriber then selects a list of individuals to receive the message and provide additional commentary. For example, the subscriber may “pull down” addresses from an address book or enter numbers associated with the recipients. Alternatively and/or additionally, by means of speech recognition module 162, the subscriber may merely speak the names (or any other associated identifier) of the individuals required for the instant conference. Enhanced voice mail system 101 then forwards the message to a voice mail box of the first individual in the list. When the individual retrieves the continuation message, then he or she receives an indication that the originator of the message would like his comments added to the message. This action may be performed by an additional alerting module 144 on the individual's media processing element 170. Enhanced voice mail system 101 then prompts the user to record his message. The received message is then mixed with the new message that is being recorded by the first individual. The mixing is performed with intelligence to provide the desired effect using mixing module 158 and intelligent agent 166. For example, using speech recognition module 162 and/or text-to-speech module 184 and speech to text module 186, enhanced voice mail system 101 matches patterns with voice energy and matches the start of the recording with the rise in voice energy to synchronize the message. As in other similar recordings, the message (or portion provided by the individual) is played back until the individual is satisfied with the recording.

When the first individual accepts invitation to join the instant conference (by pressing “send,” or other similar mechanism), enhanced voice mail system 101 sends the new version of the continuation message to the next user on the list (or in the address queue). A subscriber may choose to have a copy of the message that is stored in the originator's voice mail box after each transaction. If the continuation message remains in an individual's mail box a predetermined length of time, a status message may be sent to the originator indicating, via alerting module 144 and/or notification module 192, that the message is “stuck.” The originator then has the option of changing the order of delivery of the message or removing the individual from the list, using notification module 192 and/or navigation module 176.

In a further embodiment, enhanced voice mail system 101 supports voice advertisement from external parties to voice mail box subscribers. For example, enhanced voice mail system 101's provider may waive or reduce rental fees for a voice mail box if the subscriber agrees to receive voice advertisements. Because voice mail space is far more valuable than e-mail space, the cost to the advertiser will be higher. However, local merchants may prefer this option instead of flyers or local paper-based advertisements.

In addition or alternatively, enhanced voice mail system 100 may provide content based alerting for a subscriber, using alerting module 144. For example, a subscriber may set-up a wake-up call, reminder, or an alert call with enhanced voice mail system 101. Shortly before the appointed call time, the enhanced voice mail system 101 performs a scan of the very latest responses for accounts associated with the subscriber's voice mail address and provides them to the subscriber at the time of the call. For example, this feature may be used by an individual to receives updates, through a familiar and/or private source, before entering a meeting or giving a talk on a specific topic.

Flowchart 600 outlines steps for carrying out various operations described in FIGS. 2-4.

In step 622, user A receives a message in his or her enhanced voice mailbox system 101. The message can be in any form like voice, text, video, or a combination of these.

As a response to the message, user A may wish to initiate a conferencing operation, using conferencing module 180, shown in step 624.

In step 626, user A selects individuals or other users to participate in conferencing. User A may select other users by speaking their names, entering text or selecting from a drop down list that is present to user A as a part of a Graphical User Interface (GUI), for example, in a display system. Alternatively, user A may dial or speak unique numbers associated with each potential participant. Other ways of selecting participants for a conference using electronic media are well known to those skilled in the art and will not be described herein for sake of brevity.

During and/or after user A has decided on whom to select as a participant for the conference, user A may check availability of such users for the time of the conference, as shown in step 628. If all potential participants (or users) are available, user A may choose to connect to the conference, shown in step 632. If not, user A may wish to proceed with only some of the available users and conference with only the available users, shown in step 630. Alternatively, depending on the nature of the conference, user A may choose not to proceed with the conference, if all users are not available. Connection to the conference can be through a voice input, text input, a video input, or any combination thereof, depending on settings of conferencing module 180.

Once user A is connected to the conference, he or she may send invites to the available users and wait for acceptance from them, as shown in step 634. Further, user A may allot an importance or priority level to the conference and may make it mandatory for some of the users to attend.

In step 636, user A may wait for an acceptance for a pre-determined amount of time. If an acceptance from all users is received, user A, along with other users may begin conferencing. If not, user A may choose to wait for an additional period of time before beginning the conference and/or may send additional invites to users not selected in the first invitation.

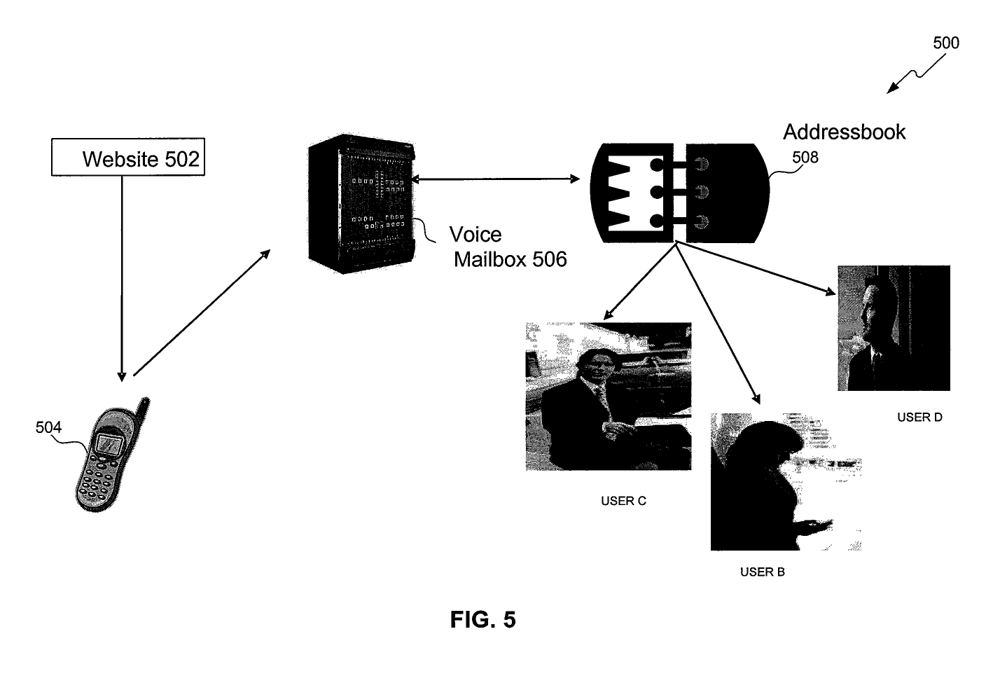

FIG. 5 provides an exemplary scenario 500 in which an embodiment of the present invention may be implemented. In an embodiment shown in FIG. 5, annotation and forwarding of a video clip by a subscriber is made possible using voice mail. Shown in FIG. 5 is a voice mailbox 506, which is another embodiment of enhanced voice mailbox system 101. In this example, user A receives a video clip from a certain website 502 via transceiver module 152. This video clip may be stored in local databases Db1-Dbn of media processing element 170. Although FIG. 5 illustrates the clip as a news video clip, the received message could be any type of content message. For example, the message could be a clip of a product advertisement by a competitor or a product review by a journalist. As shown in FIG. 5, user A provides an annotation of the clip. Voice mailbox 506 mixes the clip (using mixing module 158) and the annotation to generate the annotated message. User A then selects a set of individuals to receive the message. The selection process can be via an address book 508, via entry of individual numbers, or a similar technique. Voice mailbox 506 then forwards the annotated message substantially simultaneously to each identified recipient.

Voice mailbox 506 may also provide filtering of web based responses prior to delivery to a subscribers voice mail box, using filtering module 194. The filtering can be determined by the subscriber and/or by the network. In an embodiment, a subscriber can modify the filtering remotely through pre-determined key strokes and/or via speech signals.

In a further embodiment, voice mailbox 506 provides the ability to reconcile, assess, and/or pre-pay for services on web-sites through voice mail box 506. This can be done by a provider of e-mail services or by credit/debit cards. The provisioning of these capabilities can be provided by enhanced voice mail system 101's provider or by a third party.

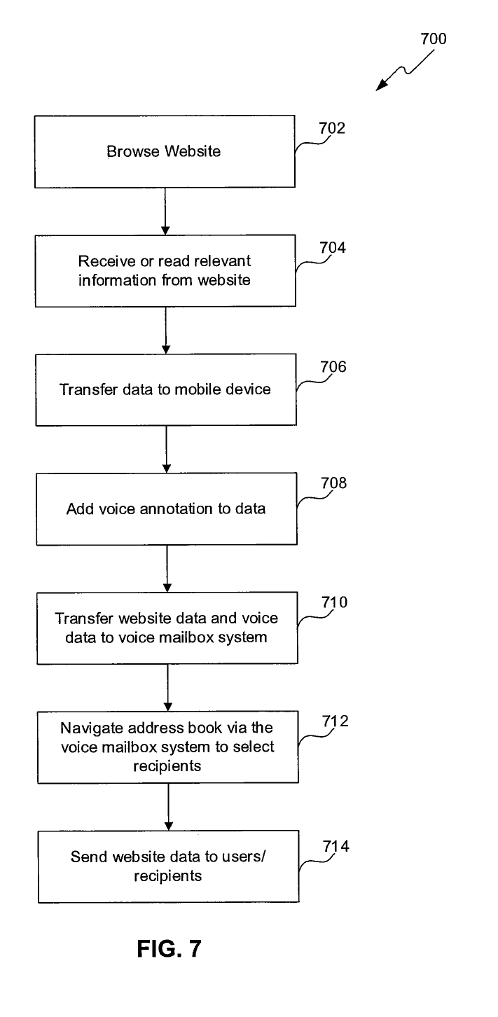

FIG. 7 shows a flowchart 700 outlining steps that may be used to implement scenario 500 shown in FIG. 5. In step 702, a user A may be browsing website 502. In step 704, user A may receive an information alert or read relevant information on website 502 and may want to forward it to other users.

To do so, in step 706, user A transfers data from website 502 to a mobile device 504, for example and not by way of limitation, a cell phone, a PDA, or the like.

In step 708, user A may choose to add comments or other voice or video annotations to the data obtained from website 502. Following step 708, user A can transfer the website data or a link to the same to voice mailbox 506, as shown in step 710.

In step 712, user A navigates his or her address book 508 to select recipients who would read data from website 502. Address book 508 may be located in the voice mail box 506 or in user A's email, or any other location obvious to one skilled in the art. Further, user A may use voice input to navigate address book 508.

User A then sends the relevant website data to various recipients selected from address book 508.

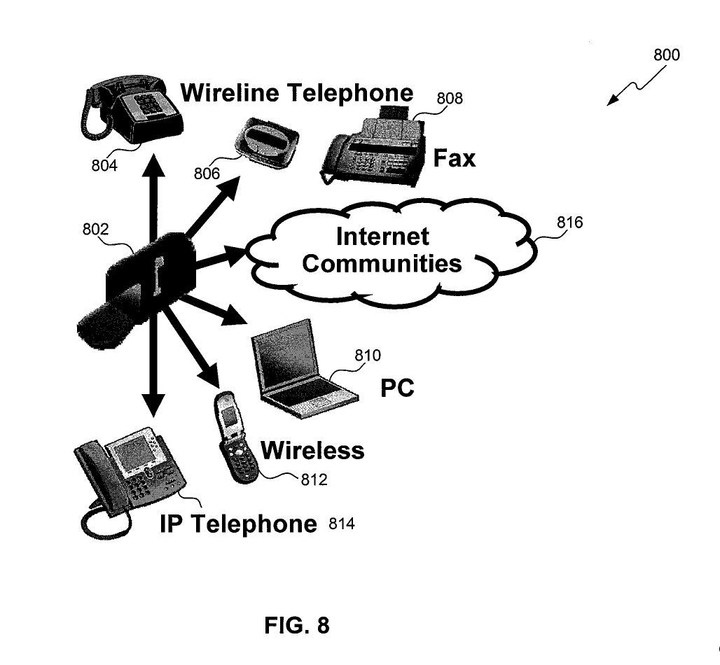

As shown in FIG. 8, voice mail system 802, may be accessed from a variety of electronic devices like a wire-line telephone 804, a pager 806, a fax machine 808, various online internet communities or websites 816, a personal computer (PC) 810, a wireless device 812, an IP telephone 814, or similar devices well known to one skilled in the art. In such a scenario, voice mail box system 802 becomes a ubiquitous tool for remote communications. Enhanced voice mailbox system 101 may be programmed in a way such that it functions as a community specific “listen-only” mailbox where one or more users can only listen to various community voice messages. For example, such voice messages may include celebrity greetings. In one example, voice mailbox system 802 can be implemented as a part of a Mereon Media Server provided by IP Unity of Duluth, Ga., USA. In an exemplary embodiment, the Mereon Media Server can be used to change setting of cookies in enhanced voice mailbox system 101. Other implementations will be apparent to one skilled in the art after reading this disclosure.

Further Description and Functionalities

Further features that are contemplated by the present invention are described below. Those skilled in the art, after reading this disclosure may find alternative and/or additional permutations and combinations that can be implemented as embodiments of this invention. For sake of brevity and to keep the discussion general, reference numerals for various elements of the present invention have been omitted in this section.

In one example, not intended to limit the invention, enhanced voice mail system 101 can provide integrated access to media rich content such as e-mail, voice mail, fax, video clips, or digital still images accessed from a variety of Internet communities. The enhanced voice mail system described herein provides the ability for a subscriber to participate in the community of activities that the Internet provides via a voice mail box while maintaining the anonymity associated with the Internet. This ability includes the retrieval of information from specific web postings/messages intended for the member and retrieval of responses to the web postings.

A user first subscribes to the enhanced voice mail service from a service provider. The service provider could be a network operator (e.g., wireline or wireless telecommunications operator) or another third party provider. In addition to providing enhanced voice mail, the enhanced voice mail provider may offer additional services to the enhanced voice mail subscriber. The services can be graduated (e.g., “a la carte” style or bundled) for different services. During the subscription and/or provisioning process the enhanced voice mail provider obtains the options and priorities of the user and provides the services accordingly.

During the registration process, the user of enhanced voice mail sets up a voice mail address by providing account information. The voice mail address allows the subscriber to perform additional functions beyond just the storage and retrieval of voice and video messages. In an embodiment, the voice mail address is similar to an e-mail address where the user of the voice mail system can classify or categorize messages received, prioritize messages, modify messages by adding audio and/or video data, forward messages to other users, filter messages based on one or more senders, and perform other operations similar to an email inbox, as will be described in more detail. Modifying messages may involve, for example, addition of accentuation depending on a language in which a message is sent or received. Additionally or alternatively, the user of the voice mail system may modify one or more messages by changing the style and type of notification(s) associated with the messages. As would be appreciated by persons of skill in the art, other types and formats for a voice mail address can be used with the present invention.

As described above, the enhanced voice mail system provides for retrieval of postings/messages from one or more web accounts. In general, a subscriber provides authorization for the enhanced voice mail provider to retrieve messages of the web for depositing into the subscriber's voice mail box and to post any responses to that message on the associated web site. This process can be done with varying security levels and with varying modes of notification and alerting. The subscriber's voice mail box can be partitioned into multiple virtual boxes to conduct a variety of operations on each of the multiple virtual boxes.

During registration (or any time after registration), the subscriber provides account and/or web posting information to the enhanced voice mail system. This information may include one or more of the address of the server/web site associated with the account or posting, the user's individual account or identifier for the site, security access codes (e.g., password), and individual posting/message identifier.

In addition to account registration, the user registers security and/or notification options associated with each registered account. In an embodiment, the subscriber has the ability to define a notification/alerting profile for an account. That is, the subscriber has the ability to set the proper notifications to indicate the deposition or clearance of messages for the subscriber's voice mail box. The notifications can be pre-defined by the enhanced voice mail provider or created or modified by the subscriber. For example, a subscriber may decide that messages from an ongoing auction in which the user is participating should use an alert tone, a phone call, or a text message sent to another end user device. In addition, the urgency level of the message could determine the schema used to alert the user. If the user does not register a notification option for a specific account, the enhanced voice mail system assigns a default notification scheme for the account.

The user may also set up “mail bins” to segregate responses or messages received at the enhanced voice mail box. One or more of the “mail bins” may be under password or other security control so that transactions on the Internet from specific communities or commercial sites are walled off from other responses. For example, when accessing the enhanced voice mail box, the user may hear a message stating “You have 3 personal messages in your dating account, 15 messages in your work account, and 1 message in your auction account.”

For example, a subscriber may go to a web site and post a message. The subscriber may then access their enhanced voice mail provider's web site to register the web site/message. For example, the subscriber may register that responses to the posted message (e.g., voice or video) should be deposited into their voice mail box with the chosen security and notification/alerting scheme (e.g., default or previous one, unless a notification scheme was specifically chosen for this transaction).

At predetermined times, or upon request by a subscriber, the enhanced voice mail system accesses one or more accounts set-up by the user. The predetermined time period may be set by the enhanced service provider or may be set by the user based on the urgency of notification required for a specific account. The order of account access is determined by the enhanced voice mail provider. As appreciated by a persons of skill in the art, accounts can be accessed in any order. The mechanism used to access the system hosting or providing the account is determined by the type of account.

For example, the enhanced voice mail service provider then acts on behalf of the user and visits the web site at pre-determined periods (e.g., depending upon the time urgency of the notification chosen) to obtain any responses to the subscriber's message. If a response has been received, the provider extracts the information (based upon the authorization received from the subscriber during the provisioning and set up) and posts it to a storage location for upload to the voice mail system with some latency allowed or for direct upload to the voice mail storage. The enhanced voice mail system then sends the pre-determined notification to the user.

In addition or alternatively, a web site may offer a tool bar or similar application which allows an individual to deposit an enhanced voice mail for a subscriber. For example, an individual may deposit a message (in text format, audio format and/or video format) on a web site for a specific subscriber. The individual can then access an option to send the message to the enhanced voice mail box of the subscriber. In this way, the message can be delivered to the subscriber's voice mail box regardless of whether the subscriber has elected to retrieve messages from this web site.

A subscriber can access his enhanced voice mail box via a communications device such as a phone, fax, personal computer (PC), personal digital assistant (PDA), cable set-top box, etc. In addition, a subscriber can access his enhanced voice mail box via the Internet. The subscriber can choose to access his voice mail box upon receipt of a notification/alert or at any other time. If the sent/received message was in text format, the user can convert it to audio and vice-versa, depending on his or her preference and convenience.

Once connected to the enhanced voice mail system and voice mail box, the subscriber can select a specific account or mail bin via voice commands or via the standard telephone keypad. A subscriber can also navigate through the responses/messages, scan messages through voice or video readout, and edit, compose or respond using voice commands or the standard telephone keypad (e.g., DTMF).

A subscriber can use the enhanced voice mail box to respond to a retrieved message. In an illustrative example, the retrieved message contains text and a recorded message. The recorded message could be simply a voice recording or it could be a recording with some chosen background (or “contextual”) sounds (e.g., similar to backgrounds in photographs). When the subscriber retrieves this message, the text may be converted to speech or only the audio portion may be delivered, based on preference determined by the subscriber. In an embodiment, the subscriber can choose to respond to this message with the original background or with a new background chosen by navigating through the telephony user interface or via voice commands. For example, a response that states “I will meet you at the beach” could be accompanied by the sound of the beach.

In addition or alternatively, the subscriber may elect to have messages of a certain content forwarded to a different mail system. For example, the subscriber may have a text e-mail message transferred to an e-mail account or a video message transferred to a cable or satellite television address for display on the television. The subscriber may also elect to have certain content types (e.g., text) converted to speech.

The enhanced voice mail system then takes responses generated by the subscriber and uploads (or otherwise provides) then to the web site from which the original message was extracted. In this way, the voice mail user maintains the anonymity provided by the Internet.

In addition to responding to the voice mail, the subscriber may decide to initiate a conference in response to one or more messages received. In an alternate embodiment, the subscriber may initiate a conference independently of received messages. The enhanced voice mail system provides the ability to make the connections to conference participants in both audio and video media.

By entering into the enhanced voice mail dialogue, the subscriber can instantly conference with as many people as desired. The list of people to contact can be created apriori, by stating names that the network provider understands, or through an address book maintained for the subscriber by the enhanced voice mail provider. As would be appreciated by persons of skill in the art, other methods for determining a contact list can be used with the present invention.

The user of the enhanced voice mail system can create group messages to forward to a single user or to a group of users. The user can mix these messages in at a pre-determined time in a round robin fashion. Further, the user can perform mixing on a bulk basis or on a message by message basis. Further still, the mixing may involve audio or video sounds that can be distinguished by a human ear, the user can select video and/or audio signals to mix from a pre-existing set of video and/or audio signals, and can edit and compose new video and audio signals using a keypad or voice input.

The user of the enhanced voice mail system has access to means for gathering information about the voice mail box. For example, the user may be informed, via notifications, about the available memory status of the voice mail box. If the memory available is small, the user may choose to receive compressed messages which can be de-compressed as and when necessary. Further, the user may perform encryption and decryption operations on the messages received and/or sent.

In another embodiment of the present invention, the user of the voice mail system can perform financial transactions using voice inputs. For example, the user can be viewing his or her bank account on a cell phone screen and at the same time be carrying out transactions by using voice input. In such a situation, the user can be, for example alerted of a payment due for a utility bill. As a response, the user can merely speak, for example, “Pay my electricity bill” and thereby pay his or her bills. As is well known to those skilled in the art, such payments can be made using any financial instrument like a credit card and/or a debit card. Using the enhanced voice mail system, a user can execute transactions involving the use of these financial instruments by using speech signals/voice input.

The enhanced voice mail system allows a user to direct information towards targeted websites by using voice messages. Vice-versa, the user may choose to receive voice and/or video messages from targeted websites after he or she has scanned those websites to extract pertinent information. This operation can be performed by a web aggregator or a content aggregator that combines information such as news, sports scores, weather forecasts and reference materials from various sources and makes it available to the users. Alternatively, the user can set preferences wherein the enhanced voice mail system can automatically scan these websites for possible malicious or undesirable content. Messages can be transmitted or received as steaming audio and/or video.

Since the enhanced voice mail system is a network based solution, the user has the flexibility to operate his or her voice mailbox remotely over a variety of communication devices.

It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

One skilled in the art will also appreciate that, for security reasons, any databases, systems, devices, servers or other devices of enhanced voice mailbox system 101 may consist of any combination thereof at a single location or at multiple locations, wherein each database or system includes any of various suitable security features, such as firewalls, access codes, encryption, decryption, compression, decompression, and/or the like.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format.

Data sets may be stored using any suitable technique, including, for example, storing consumer files using an ISO/IEC 7414-4 file structure; implementing a domain whereby a dedicated file is selected that exposes one or more elementary files containing one or more data sets; using data sets stored in consumer files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7414-6 data elements; stored as ungrouped data elements encoded using ISO/IEC Abstract Syntax Notation (ASN.1) as in ISO/IEC 8428 and 8825; and/or other proprietary techniques that may include fractal compression methods, image compression methods, etc. In one exemplary embodiment, the ability to store a wide variety of information in different formats is facilitated by storing the information as a BLOB. Thus, any binary information can be stored in a storage space associated with a data set. As discussed above, the binary information may be stored on the financial payment instrument or external to but affiliated with the financial payment instrument.

The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial payment instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets. As stated above, in various embodiments of the present invention, the data can be stored without regard to a common format.

However, in one exemplary embodiment of the present invention, the data set (e.g., BLOB) may be annotated in a standard manner when provided for manipulating the data onto the financial payment instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like.

Each of these condition annotations are further discussed herein. The data set annotation may also be used for other types of status information as well as various other purposes. For example, the data set annotation may include security information establishing access levels. The access levels may, for example, be configured to permit only certain consumers, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the payment instrument user at the stand alone device, the appropriate option for the action to be taken.

The present invention may contemplate a data storage arrangement wherein the header or trailer, or header or trailer history, of the data is stored on the payment instrument in relation to the appropriate data.

One skilled in the art will also appreciate that, for security reasons, any databases, systems, devices, servers or other devices of enhanced voice mailbox system 101 may consist of any combination thereof at a single location or at multiple locations, wherein each database or system includes any of various suitable security features, such as firewalls, access codes, encryption, decryption, compression, decompression, and/or the like.

Enhanced voice mailbox system 101 may be described herein in terms of functional block components and various processing steps. It should be appreciated that such functional blocks may be realized by any number of hardware and/or software components configured to perform the specified functions. For example, enhanced voice mailbox system 101 may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, system 200 may be used to detect or prevent security issues with a client-side scripting language, such as JavaScript, VBScript or the like.

As will be appreciated by one of ordinary skill in the art, system 200 may be embodied as a customization of an existing system, an add-on product, upgraded software, a stand-alone system, a distributed system, a method, a data processing system, a device for data processing, and/or a computer program product. Accordingly, enhanced voice mailbox system 101 may take the form of an entirely software embodiment, an entirely hardware embodiment, or an embodiment combining aspects of both software and hardware. Furthermore, enhanced voice mailbox system 101 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for providing an enhanced voice mail system integrating rich media content from a website; comprising:
receiving information associated with an account held by a user on the website, wherein the account information includes an address of a web server hosting the website, an account identifier for the user, and security access information corresponding to the user for use by the enhanced voice mailbox system;
retrieving, upon occurrence of an event, a message associated with the account on the website;
transmitting a notification to the user;
providing a summary of messages stored for the user;
receiving a voice input based selection of a message from the user;
receiving a voice based response to the selected message from the user; and
posting the voice based response to the selected message in the account on the web site associated with the selected message.

2. The method of claim 1, wherein the step of receiving information includes assigning an identifier to a specific posted message.

3. The method of claim 1, wherein the step of retrieving occurs after the passage of a pre-determined period of time.

4. The method of claim 1, further comprising categorizing the summary of messages by separating into a plurality of categories, wherein the categories are established by the user.

5. The method of claim 1, wherein the step of receiving the voice input based selection of a message includes adding at least one of background audio and background video to the message.

6. The method of claim 1, further comprising:
mixing the received response with a first background audio stream.

7. The method of claim 1, further comprising:
mixing the received response with a background video stream.

8. The method of claim 6, wherein the step of mixing further comprises modifying a second background audio stream included in the received message.

9. The method of claim 7, wherein the step of mixing further comprises modifying a second background video stream included in the received message.

10. The method of claim 6, wherein the first background audio stream is selected by the user from a list of available background audio streams.

11. The method of claim 7, wherein the first background video stream is selected by the user from a list of available background video streams.

12. The method of claim 1, further comprising executing voice based search queries using the enhanced voice mail system.

13. The method of claim 1, further comprising navigating the website using the enhanced voice mail system.

14. The method of claim 4, further comprising voice input driven prioritizing of the messages after they have been categorized.

15. A method for providing a continuation message, comprising:
(a) receiving a first message from a first user;
(b) receiving a set of recipient user addresses from the first user;
(c) forwarding the continuation message to a second user in the set of recipient user addresses;
(d) receiving a second message from the second user and mixing the second message with the first message, wherein the second message is superimposed with the first message; and
(e) repeating steps (c) and (d) for each user in the set of recipients.

16. The method of claim 15, further comprising adding accentuation to one or more messages after step (e).

17. The method of claim 15, wherein the mixing can occur at a pre- determined time.

18. The method of claim 17, wherein the mixing is performed in a round-robin fashion.

19. The method of claim 17, wherein the mixing is performed either on a bulk basis or on a message by message basis.

20. The method of claim 15, wherein the steps of receiving and forwarding occur at one or more communication devices.

21. An enhanced voice mailbox system, comprising:
a messaging module 174;
an answering module 172;
an alerting module 144;
a web aggregator module 162 to retrieve information from web-postings and to note responses to the web-postings from the voice mailbox; and
one or more mail bins 178 for categorizing one or more voice mails received by the voice mail box system.

22. The enhanced voice mailbox system of claim 21, wherein the voice mailbox is network based.

23. The enhanced voice mailbox system of claim 21, wherein each of one or more mail bins 178 are allotted to individual senders of voice mails.

24. The enhanced voice mailbox system of claim 21, further comprising:
storage and retrieval modules 196 and 190 for storing and retrieving one or more background audio frequencies associated with one or more voice messages received by the voice mailbox system; and
a transceiver module 152 to transmit and receive said one or more background audio frequencies as a response to the associated one or more voice messages received by the voice mailbox system.

25. The enhanced voice mailbox system of claim 21, further comprising:
a conferencing module 180 to respond to one or more external users;
a notification module 192 to notify the user about available voice mailbox memory;
a filtering module 194 to block undesirable messages sent to the voice mailbox system;
a navigation module 176 to navigate through a plurality of messages in the voice mailbox system; and
a mixing module 158 to create group greetings.

26. The system of claim 25, wherein the conferencing module 180 is used as a means for conferencing in one or more of audio or video media.

27. The system of claim 25, wherein the notification module 192 communicates with storage and retrieval modules 196 and 190 for deposition and/or clearance of messages from the voice mailbox system.

28. The system of claim 25, wherein the user of the voice mailbox system a has a means for modifying one or more received notifications via the notification module 192.

29. The system of claim 28, wherein the means for modifying is based on a priority level pre-set by the user of the voice mailbox system.

30. The system of claim 25, wherein the user of the voice mailbox system can operate the filtering module 194 remotely through pre-determined key strokes and speech signals.

31. The system of claim 25, wherein the navigation module 176 is configurable by at least one of following means:
(a) scanning;
(b) editing;
(c) composing; and
(d) responding via a dual tone multiple frequency keypad.

32. The system of claim 25, wherein the mixing module 158 has means for superimposing audio signals in a way such that the audio signals are distinguishable from each other by a human ear.

33. The system of claim 25, wherein the mixing module 158 has means for adding new audio signal to a pre-existing set of audio signals in the voice mailbox system.

34. A computer program product for seamlessly accessing a voice mailbox system through network enabled devices having a computer program logic recorded thereon for controlling at least one processor, the computer program logic comprising:
computer program code means for hosting speech recognition, text to speech conversion, tone recognition and tone generation;
computer program code means for mixing multiple media onto a single stream, wherein each of said multiple media can be modified by a user accessing the voice mailbox;
computer program code means for encoding and decoding audio and video signals associated with one or more messages in the voice mailbox system;
computer program code means for compressing and de-compressing audio and video signals associated with one or more messages in the voice mailbox system;
computer program code means for extracting pertinent information from a targeted websites;
computer program code means for depositing information requested by a state machine to a specific storage location;
computer program code means for detecting information patterns for actions performed on state based actions;
computer program code means for retrieving information from the storage location and delivering retrieved information to the targeted website based upon specific instructions contained about the information;
computer program code means for generating and receiving messages regarding a status of contents of the storage location; and
computer program code means for making and receiving audio and video calls to one or many parties simultaneously.
